(19) United States
(12) Patent Application Publication
(10) Pub. No.: US 2003/0101301 A1
(43) Pub. Date: May 29, 2003

(54) INTERRUPTION PROCESSING CIRCUIT HAVING AN INTERRUPTION CONTROL UNIT HAVING A SHORT TIME BETWEEN AN INTERRUPTION REQUEST AND START OF EXECUTION OF INTERRUPTION SERVICE ROUTINE

(76) Inventor: MASAHIRO TANIGUCHI, TOKYO (JP)

Correspondence Address: BURNS DOANE SWECKER & MATHIS L L P, POST OFFICE BOX 1404, ALEXANDRIA, VA, 22313-1404, US

(21) Appl. No.: 09/437,400

(22) Filed: Nov. 10, 1999

(30) Foreign Application Priority Data
Jun. 18, 1999 (JP) 11-172904

(51) Int. Cl. G06F 13/24; G06F 15/00; G06F 9/44; G06F 9/00; G06F 7/38

(52) U.S. Cl. 710/260

(57) ABSTRACT

An interruption processing device having an ICU is intended to speed up the process from generation of an interruption request until commence of execution of the corresponding interruption service routine. The ICU is provided with an interruption accepting section for accepting interruption requests sent from a plurality of interruption factors; a factor deciding register for storing factor numbers corresponding to the accepted interruption requests; an interrupt vector table for storing branch instructions corresponding to the respective interruption factors; a selector for selecting a corresponding branch instruction from the interrupt vector table, based on the factor numbers stored in the factor deciding register; and a writing section for writing the selected branch instruction onto an interrupt vector of EIT vector.

### FIELD OF THE INVENTION

The present invention relates to a device for executing high-speed processing of interruption in a system using CPU (Central Processing Unit).

### BACKGROUND OF THE INVENTION

Conventionally, as shown in FIG. 12, a CPU 1 having EIT vectors for EIT (Exception Interruption Trap) factors is provided with interruption terminals 11, 12, 13, 14, . . . one for each of interrupt vectors INT0, INT1, INTn−1 and INTn so that interruption request signals issued by peripheral units (not shown) can be input through the individual interruption terminals 11, 12, 13, 14, . . . . The CPU 1 having such a construction is provided with the interrupt vectors INT0, INT1, . . . , INTn−1 and INTn for their respective interruptions. Those interrupt vectors INT0, INT1, . . . , INTn−1 and INTn are all included in the EIT vectors 15, as shown in FIG. 13, so that when an interruption occurs, the CPU 1 executes the instruction stored in the corresponding interrupt vector.

Usually, branch instructions are stored in the interrupt vectors, and actual interruption service routines are stored in a branch destination of the branch instruction. In this construction, the time from generation of the interruption request until commence of execution of the corresponding interruption service routine is shortened. However, since decision on priorities of the interruption factors and masked states thereof and selection of the interrupt vectors are made by hardware, there is a disadvantage that with increasing number of interruption factors, construction of the hardware becomes complicated and the circuit scale is enlarged.

Accordingly, an ICU (Interruption Control Unit) 3 is provided between a CPU 2 and not illustrated peripheral units as shown in FIG. 14, whereby a plurality of interruption factors issued by the peripheral units are integrated in the ICU 3 to be corresponded to a less interrupt vectors. In this construction, the CPU 2 is provided with interruption terminal less in number than the interruption factors issued by the peripheral units. For example, the CPU 2 is provided with a single interruption terminal 21, and can receive the request of interruption from the ICU 3 through this interruption terminal 21.

Specifically, the ICU 3 is provided with individual interruption terminals 31, 32, 33, 34, . . . for receiving the interrupt request allocated to their respective interruption factors, whereby the plurality of interruption factors are integrated in a group to be posted to the CPU 2 through the interruption terminal 21 of the CPU 2. Thus, the CPU 2 is only needed to have one interruption factor and one interruption terminal. Further, as shown in FIG. 15, only a single interrupt vector INT in the EIT vectors 22 is prepared. Accordingly, when an interruption is posted to the CPU 2, the CPU 2 is simply required to execute the interrupt vector INT in address XX of the EIT vectors 22 all the time. Therefore, it can simplify the hardware construction of the CPU 2 and can reduce the circuit size as well.

However, because there exists several interruption factors, correct information is required to decide where the interruption comes from when an interruption is posted to the CPU 2. The ICU 3 has a register 35 (hereinafter referred to as the factor deciding register) to decide such a thing and it stores the information about the interruption source in its factor deciding register 35.

Also, the interrupt vector INT stored in address XX of the EIT vectors 22 is common to the plurality of interruption factors, so that additional interrupt vectors for their respective interruption factors are necessary. For this reason, there is provided an interrupt vector table 37, as shown in FIG. 16, in which the interrupt vectors INT0, INT1, . . . , INTn−1 and INTn corresponding to their respective interruption factors are stored.

In the construction shown in FIG. 14, when an interruption occurs, the CPU2 executes the interruption service routine corresponding to the interrupt vector INT stored in address XX of the EIT vectors 22. When executing the interruption service routine, the information stored in the factor deciding register 35 in the ICU 3 is read out. Then, the source of the interruption request is decided with reference to the information in the factor deciding register 35. The CPU 2 refers to the interrupt vector table 37 and branches to the interrupt vector INT0, INT1, . . . , INTn−1, INTn corresponding to the interruption request at the source. Thus, the interruption service routine corresponding to the interruption request generated from the interruption factor is executed. Because software executes this series of process and manages interruption vectors INT0, INT1, . . . , INTn−1 and INTn, flexible memory arrangement can be achieved.

However, this conventional construction has ICU 3 find a disadvantage that the number of process executed by software will increase because the software needs to decide the interruption factor and execute the branching process as well. In other words, it has been consuming extra time to execute the interruption service routine corresponding to its interruption factor. It is because when the interruption request occurs, the actual interruption service routine is not executed until the factor deciding register 35 is read according to the interruption vector INT0, INT1, . . . , INTn−1, INTn which corresponds to the interruption source. Thus, it disadvantageously takes lots of time from generation of the interruption request until the commence of execution of the corresponding interruption service routine.

### SUMMARY OF THE INVENTION

It is an object of the present invention to provide an interruption processing device to improve the disadvantage described above, and aims for having an interruption processing device which can execute the interruption service routine faster corresponding to an occurred interruption request in an interruption processing device which has ICU.

According to the first aspect of the present invention, when the interruption accepting section of the interruption controlling unit accepts the interruption requests sent from the plurality of interruption factors, the information for specifying the interruption factors which are a source of the interruption requests is stored in the decision information storing section. Based on the information stored in the decision information storing section, the selecting section of the interruption controlling unit selects a corresponding branch instruction from the interrupt vector table in which the branch instructions to the interruption service routines corresponding to their respective interruption factors are stored. Then, the writing section of the interruption controlling unit writes the corresponding branch instruction onto a designated interrupt vector in the EIT vectors and simultaneously posts the interruption to the CPU. Then, when the CPU reads the branch instruction written in the designated interrupt vector, the CPU executes the interruption service routine stored in the branch destination of the branch instruction.

According to the second aspect of the present invention, when the interruption accepting section of the interruption controlling unit accepts the interruption requests sent from the plurality of interruption factors, the information for specifying the interruption factors which are a source of the interruption requests is stored in the decision information storing section. Based on the information stored in the decision information storing section, the selecting section of the interruption controlling unit selects a corresponding branch instruction from the interrupt vector table in which the branch instructions to the interruption service routines corresponding to their respective interruption factors are stored. Then, the writing section of the interruption controlling unit writes the corresponding branch instruction onto the selected instruction storing section and simultaneously posts the interruption to the CPU. Then, when the CPU intends to read the branch instruction, the reading section of the interruption controlling unit reads the branch instruction written in the selected instruction storing section, instead of the branch instruction stored in the interrupt vector in the EIT vectors which should originally be read out. The CPU executes the interruption service routine stored in the branch destination of the branch instruction as read.

According to the third aspect of the present invention, when the interruption accepting section of the interruption controlling unit accepts the interruption requests sent from the plurality of interruption factors, the information for specifying the interruption factors which are a source of the interruption requests is stored in the decision information storing section. Based on the information stored in the decision information storing section, the selecting section of the interruption controlling unit selects a corresponding branch instruction from the interrupt vector table in which the branch instructions to the interruption service routines corresponding to their respective interruption factors are stored and posts the interruption to the CPU. Then, when the CPU intends to read the branch instruction, the reading section of the interruption controlling unit reads out the selected branch instruction, instead of the branch instruction stored in the interrupt vector in the EIT vectors which should originally be read out. The CPU executes the interruption service routine stored in the branch destination of the selected branch instruction.

Other objects and features of this invention will become apparent from the following description with reference to the accompanying drawings.

### BRIEF DESCRIPTION OF THE DRAWINGS

FIG. 1 is a block diagram showing the first embodiment of an interruption processing device according to the present invention;

FIG. 2 is a block diagram showing principal sections of a variant of the first embodiment;

FIG. 3 is a schematic view showing a construction of EIT vectors of a CPU shown in FIG. 2;

FIG. 4 is a schematic view showing a construction of interrupt vector tables of respective interruption factors managed by the ICU shown in FIG. 2;

FIG. 5 is a schematic view showing a construction of individual interrupt vector tables integrated into INT2 of the interrupt vector table shown in FIG. 4;

FIG. 6 is a block diagram showing principal sections of an another variant of the first embodiment;

FIG. 7 is a schematic view showing a construction of the EIT vectors of the CPU shown in FIG. 6;

FIG. 8 is a schematic view showing a construction of interrupt vector tables of respective interruption factors managed by the ICU shown in FIG. 6;

FIG. 9 is a schematic view showing a construction of the individual interrupt vector tables integrated into INT22 of the interrupt vector tables shown in FIG. 8;

FIG. 10 is a block diagram showing the second embodiment of the interruption processing device according to the present invention;

FIG. 11 is a block diagram showing the third embodiment of the interruption processing device according to the present invention;

FIG. 12 is a block diagram for illustrating a conventional relation of the connection between the CPU to which interruption requests are directly input and the interruption terminals;

FIG. 13 is a schematic diagram showing a construction of the EIT vectors of the CPU shown in FIG. 12;

FIG. 14 is a block diagram for illustrating a conventional relationship in connection between the CPU to which interruption requests are input through the ICU and the interruption terminals and the ICU;

FIG. 15 is a schematic diagram showing a construction of the EIT vectors of the CPU shown in FIG. 14; and

FIG. 16 is a schematic diagram showing the construction of the interrupt vector tables of respective interruption factors in the ICU shown in FIG. 14.

### DESCRIPTION OF THE PREFERRED EMBODIMENTS

Preferred embodiments of an interruption processing device according to the present invention will be described below with reference to the accompanying drawings.

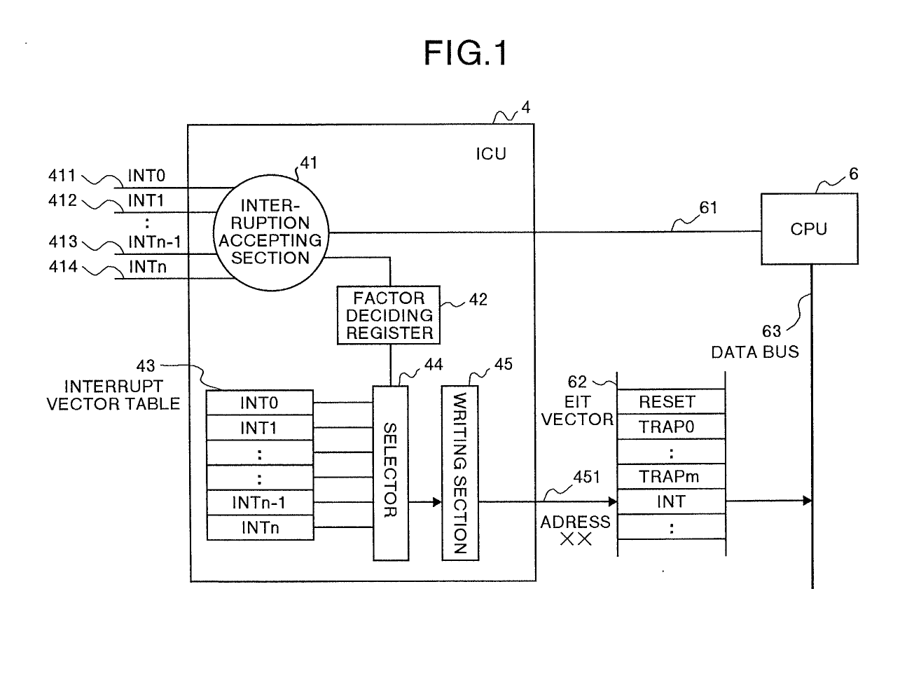

FIG. 1 is a block diagram showing the first embodiment of an interruption processing device according to the present invention. The interruption processing device is provided with an ICU (Interruption Control Unit) 4 and a CPU 6. The ICU 4 is provided with an interruption accepting section 41, a factor deciding register 42 which is the decision information storing section, an interrupt vector table 43, a selector 44 which is a selecting section and a writing section 45.

The interruption accepting section 41 receives interruption requests sent from a plurality of interruption factors through a plurality of interruption terminals 411, 412, 413, 414, . . . connected to the plurality of not illustrated interruption factors, and decides acceptance levels of the interruption and proprieties of the interruption, based on priorities and masked states of the interruption factors. Also, the interruption accepting section 41 sends factor numbers for specifying the interruption factors which are sources of the accepted interruption requests to the factor deciding register and also sends the interruption request to the CPU 6 through an interruption terminal 61 connected to the CPU 6.

The factor deciding register 42 stores therein the factor numbers of the interruption factors accepted by the interruption accepting section 41. The interrupt vector table 43 stores interruption service routines corresponding to respective interruption factors or branch instructions to an address of areas in which the interruption service routines are stored on an interruption factor basis and is formed by, for example, a register. The interruption service routines are stored in a storage unit not shown. It is noted here that while the branch instruction to the interruption service routine is generally stored in the interrupt vector, when the interruption service routine is terminated by only one instruction, or when the CPU prepares a some instructions' area for one interruption factor, for example, the interruption service routine itself may be stored in the interrupt vector.

Based on the factor numbers stored in the factor deciding register 42, the selector 44 selects a branch instruction to the top address of the area storing therein a corresponding interruption service routine from the interrupt vector table 43. The writing section 45 writes the branch instruction selected by the selector 44 onto the interrupt vector INT (address XX) of the EIT vectors 62 of the CPU 6 through a writing line 451 including a CPU bus or a specifically designed writing pass. The writing of the branch instruction is performed in the same cycle as the cycle in which the interruption accepting section 41 sends the interruption request the CPU 6.

After receiving the interruption request sent from the interruption accepting section 41 of the ICU 4 through the interruption terminal 61, the CPU 6 fetches the branch instruction written on the interrupt vector INT of the EIT vectors 62 (address XX) and executes it, and thereby the interruption service routine stored in the area to which the branch instruction branches is executed.

Operation of the interruption processing device of the first embodiment will be described next. First, before a system including the interruption processing device having the structure shown in FIG. 1 is booted, circuits of the system are initialized and the interrupt vector table 43 in the ICU 4 is initialized. Then, the branch instructions to the top address in the areas of a not illustrated storage device, in which the interruption service routines one for each of not illustrated interruption factors, are stored are set in the interrupt vector table 43.

After an interruption request is generated from the interruption factor, the interruption accepting section 41 decides acceptance levels of the interruption and proprieties of the interruption, for determination of the interruption factors to be accepted. Then, the interruption accepting section 41 outputs the factor number for specifying the accepted interruption factor to the factor deciding register 42, so that the factor number is stored in the factor deciding register 42.

When the factor number is stored in the factor deciding register 42, the selector 44 selects from the interrupt vector table 43 the branch instruction to the top address in the storage area in which the interruption service routine of the interruption factor corresponding to the factor number is stored. Then, the writing section 45 writes the output value of the selector, i.e., the branch instruction selected from the interrupt vector table 43 by the selector 44, onto the interrupt vector INT (address XX) in the EIT vectors 62. Also, when the factor number is stored in the factor deciding register 42, the interruption accepting section 41 outputs the interruption request to the CPU 6 through the interruption terminal 61.

When the CPU 6 receives the interruption request it fetches the branch instruction stored in the address XX of the EIT vectors 62 and executes it. This causes the branch instruction to jump to the area for the branch destination of the branch instruction, so that the execution of the desired interruption service routine is started.

According to the aforementioned first embodiment, the ICU 4 accepts the interruption requests from the plurality of interruption factors by use of the interruption accepting section 41 and stores the factor numbers corresponding to the accepted interruption requests in the factor deciding register 42. With reference to the stored factor numbers, a corresponding branch instruction is selected from the interrupt vector table 43 by use of the selector 44, and then the selected branch instruction is written on the interrupt vector INT in the EIT vectors 62 by use of the writing section 45. Then, when receiving the interruption request from the interruption accepting section 41, the CPU 6 reads out the branch instruction written in the interrupt vector INT in the EIT vectors 62 and executes the interruption service routine of the branch destination of the branch instruction. As a result, the process to make a decision on the interruption-request-originated interruption factor by software can be omitted, so that the time from generation of the interruption request until commence of execution of the corresponding interruption service routine is shortened.

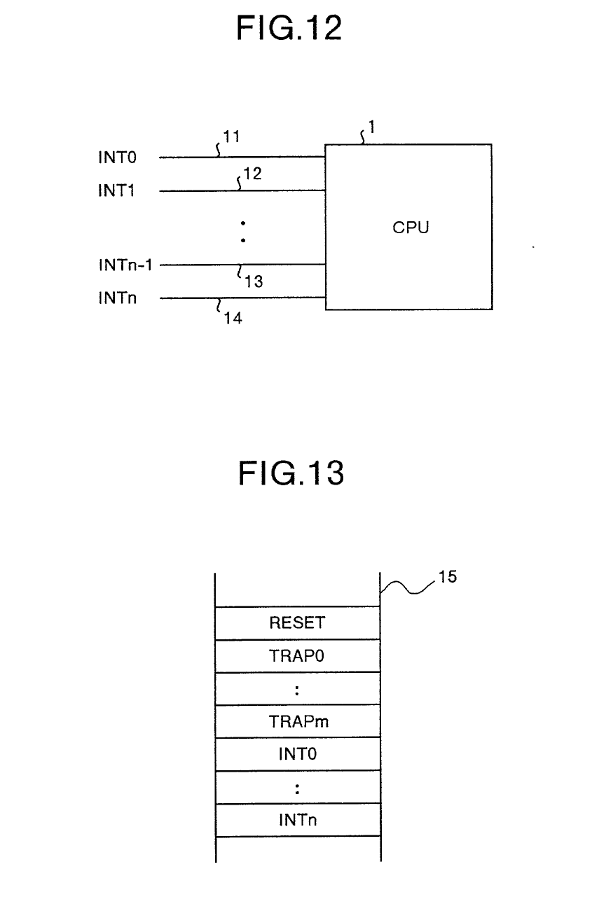

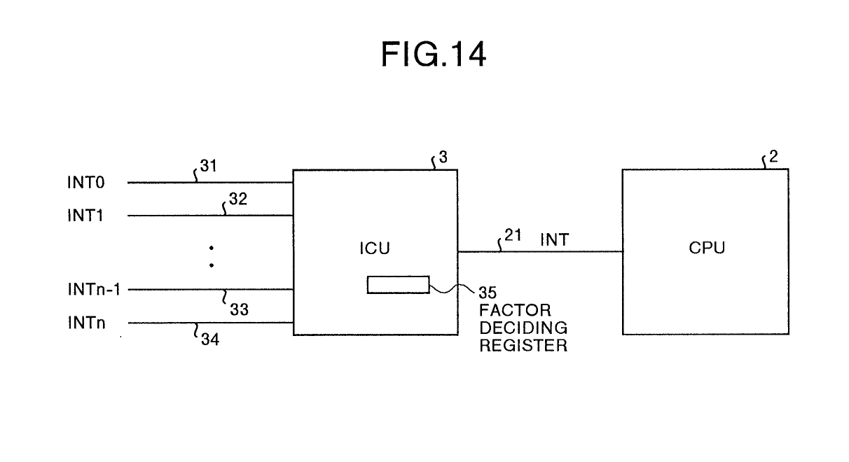

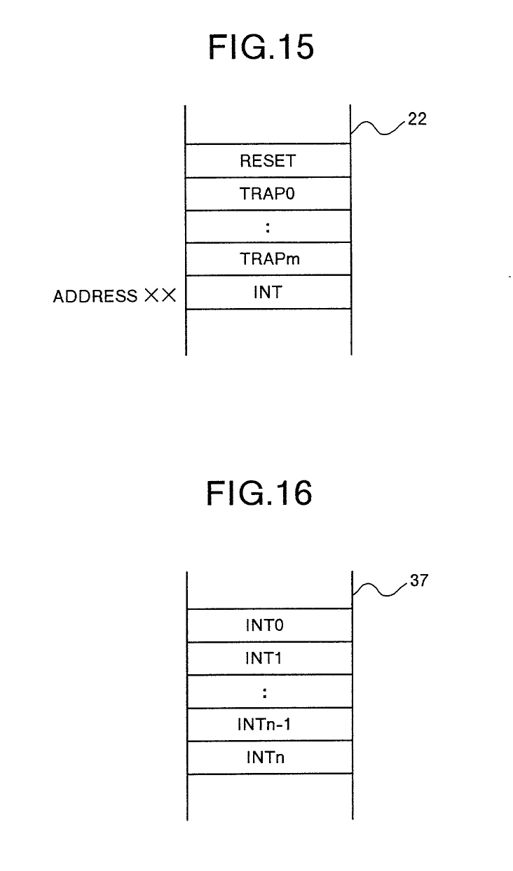

Also, according to the aforementioned first embodiment, the hardware construction of the interruption handling section of the CPU can be curtailed and resultantly the scale of the circuits is reduced, as compared with the conventional CPU using no ICU (see FIG. 12).

While in the aforementioned first embodiment, the interrupt vector table 43 is formed by the register, it may be formed by semiconductor memory such as SRAM (static RAM), DRAM (dynamic RAM) or EEPROM (electrically erasable PROM), without limiting to the register. If change of the interrupt vector table 43 is unnecessary, the interrupt vector table 43 may be formed by ROM or combinatorial circuits. In these cases, the semiconductor memory such as SRAM, DRAM, EEPROM or ROM may be an internal memory of the ICU 4 or a discrete memory IC (an external memory). When the memory is provided as an external memory, the circuit scale of the ICU 4 can be reduced.

While the CPU 6 in the aforementioned first embodiment is provided with no internal cache memory, the CPU 6 may be provided with the internal cache memory. In this case, there may be provided an additional circuit having the function of inhibiting a specific program area, i.e., the EIT vectors 62 from being cached. In this case, a possible malfunction which may be caused by the interrupt vector INT in the EIT vectors 62 being changed by the ICU 4 can be prevented.

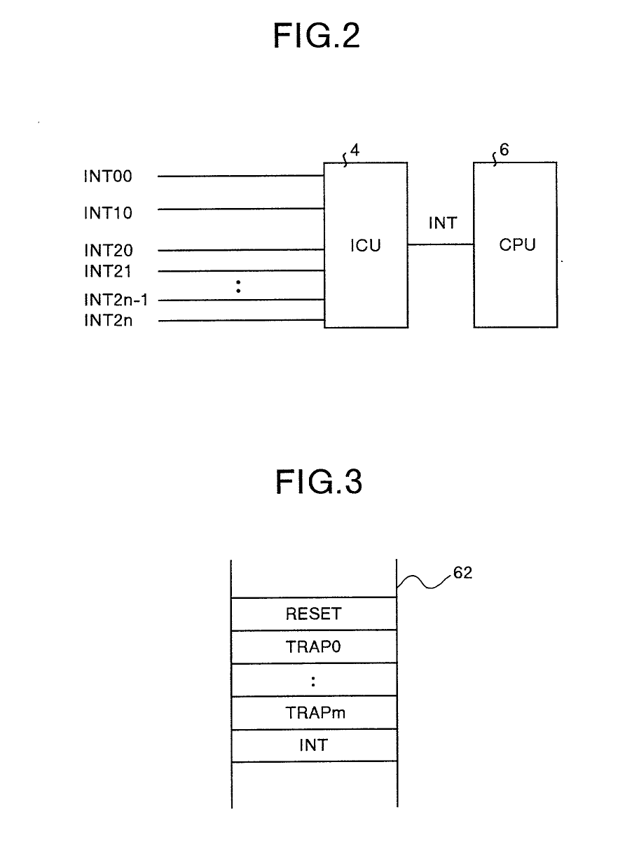

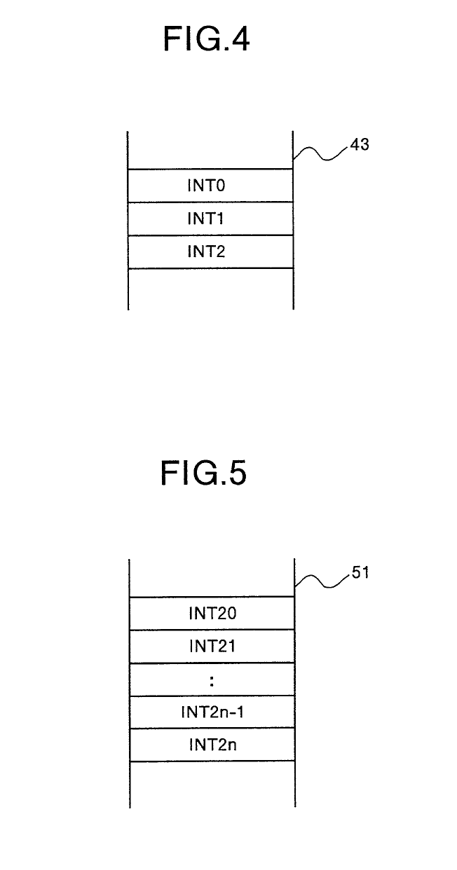

Further, while in the aforementioned first embodiment, the interrupt vectors are specifically allocated to their respective factors, this is not of limitative. Modification may be made such as, for example, shown in FIGS. 2 to 5 that the interrupt vectors INT00 and the INT10 from the interruption factors which require the interruption handling to be executed at a high speed occupy the interrupt vectors INT0 and INT1 respectively of the interrupt vector table 43 (see FIG. 4) in ICU 4. On the other hand, the interrupt vectors INT20, INT21, . . . , INT2n−1 and INT2n from a plurality of interruption factors which do not require the interruption handling to be executed at a high speed share the interrupt vector INT2 of the interrupt vector table 43 in ICU 4.

Regarding the plurality of interruption factors which share the interrupt vector INT2, modification may be made such that the interruption factors from which the interruption requests are originated are decided by software. In this case, an interrupt vector table 51 for INT2 is provided as shown in FIG. 5 for the interrupt vectors INT20, INT21, . . . , INT2n−1 and INT2n which were integrated into INT2. This modification can achieve optimization in scale of the hardware necessary to a system LSI and in software processing speed and freedom in arrangement.

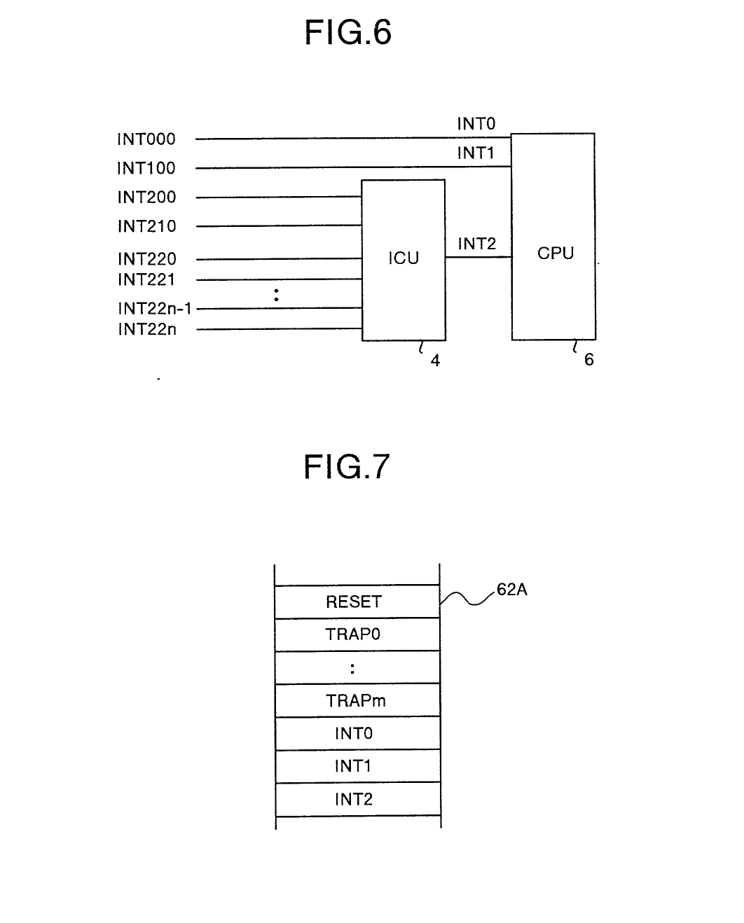

Furthermore, while in the aforementioned first embodiment, all interruption requests from the plurality of interruption factors are accepted by the ICU 4, this is not of limitative. Modification may be made such as, for example, as shown in FIGS. 6 to 9 such that the interrupt vectors INT000 and INT100 from the interruption factors occupy the interrupt vectors INT0 and INT1 respectively in an EIT vector table 62A (see FIG. 7). On the other hand, the interrupt vectors INT200, INT210, INT220, INT221, . . . , INT22n−1 and INT22n from the plurality of interruption factors share the interrupt vector INT2 in the EIT vector table 62A.

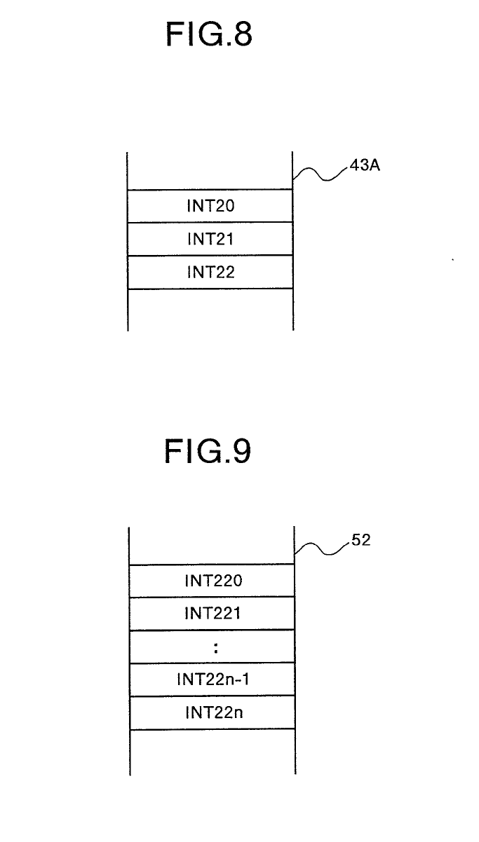

A further modification may be made such that the interrupt vectors INT200 and INT210 from the interruption factors occupy the interrupt vectors INT20 and INT21 respectively in the interrupt vector table 43A (see FIG. 8) in the ICU 4. On the other hand, theinterruptvectorsINT220, INT221, . . . , INT22n−1 and INT22n from the plurality of interruption factors share the interrupt vector INT22 of the interrupt vector table 43A in the ICU 4. Regarding the plurality of interruption factors which share the interrupt vector INT22, modification may be made such that the interruption factors from which the interruption requests are originated are decided by software. In this case, an interrupt vector table 52 for the INT22 is provided as shown in FIG. 9 for the interrupt vectors INT220, INT221, INT22n−1 and INT22n which were integrated into the INT22.

This modification enables a priority encoder section of the hardware to be distributed to the ICU 4 and the CPU 6, so that a reduced circuit speed load can be produced. This can provide increased clock frequencies and thus improved performances of LSI. Also, this can achieve further optimization in scale of the hardware necessary to the system LSI and in software processing speed and freedom in arrangement, as compared with the illustrated examples shown in FIGS. 2 to 5.

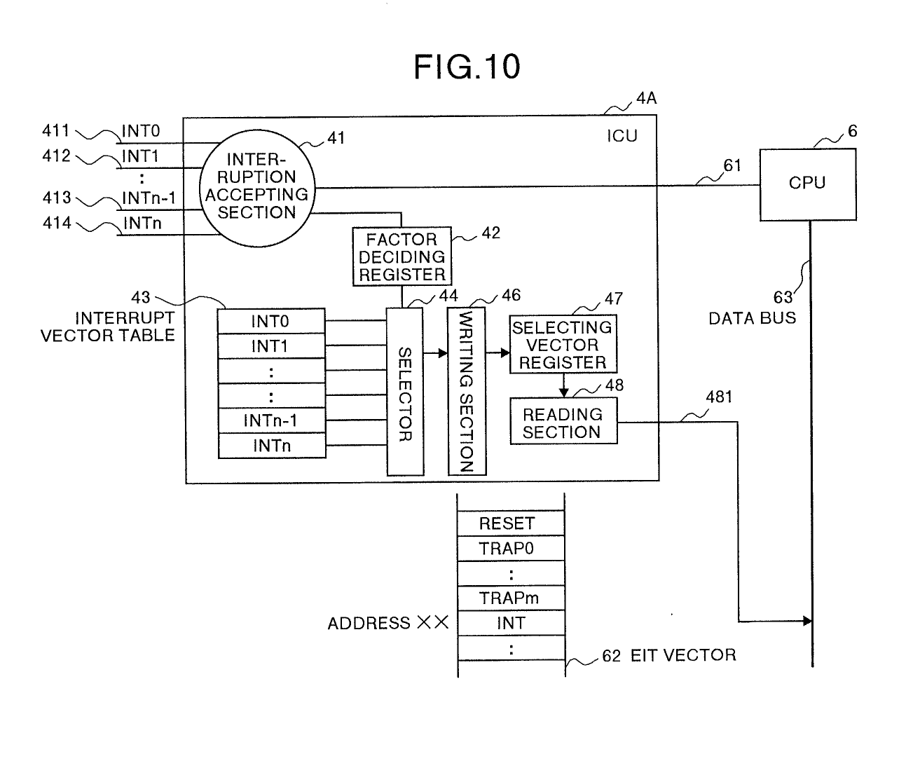

FIG. 10 is a block diagram showing the second embodiment of the interruption processing device according to the present invention. The interruption processing device of the second embodiment differs from that of the first embodiment in that it uses the ICU 4A which has the construction described below instead of the ICU 4 of the first embodiment, and when CPU 6 tries to read out the interruption vector INT, it sends the branch instruction stored in the deciding vector register 47 instead of the interruption vector INT to the address of the area which stores in the interruption service routines corresponding to the interruption factors through the writing line 481 and the data bus 63 without changing the interruption vector INT of the EIT vectors 62. The constructional features identical to those of the first embodiment are given the same reference numerals, and explanation thereof will be omitted.

The ICU 4A includes the interruption accepting section 41, the factor deciding register 42 which is the decision information storing section, the interrupt vector table 43, the selector 44 which is the selecting section, the selecting vector register 47 which is the selected instruction storing section, a writing section 46 onto which a branch instruction selected by the selector 44 is written in the selecting vector register 47, and a reading section 48 for reading out the branch instruction stored in the selecting vector register 47. It is constructed such that when the CPU 6 intends to read out the interrupt vector INT in the EIT vectors 62, the reading section 48 reads out the contents of the selecting vector register 47, instead of the interrupt vector INT.

Operation of the interruption processing device of the second embodiment will be described next. First, before a system including the interruption processing device having the structure shown in FIG. 10 is booted, circuits of the system are initialized and the interrupt vector table 43 in the ICU 4A is initialized. Then, the branch instructions to the top address in the areas in the storage device, not shown, in which the interruption service routines one for each of interruption factors, not shown, are stored are set in the interrupt vector table 43.

After an interruption request is generated from the interruption factor, not shown, the interruption accepting section 41 decides acceptance levels of the interruption and proprieties of the interruption, for determination of the interruption factors to be accepted. Then, the interruption accepting section 41 outputs the factor number for specifying the accepted interruption factor to the factor deciding register 42, so that the factor number is stored in the factor deciding register 42.

When the factor number is stored in the factor deciding register 42, the selector 44 selects from the interrupt vector table 43 the branch instruction to the top address in the storage area in which the interruption service routine of the interruption factor corresponding to the factor number is stored. Then, the writing section 46 writes the output value of the selector, i.e., the branch instruction selected from the interrupt vector table 43 by the selector 44, onto the selecting vector register 47. Also, when the factor number is stored in the factor deciding register 42, the interruption accepting section 41 outputs the interruption request to the CPU 6 through the interruption terminal 61.

When receiving the interruption request, the CPU 6 goes into action to fetch the interruption vector INT stored in address XX of the EIT vectors 62. At this time, the reading section 48 reads out the contents stored in the selecting vector register 47, instead of in address XX. Therefore, the CPU 6 fetches the branch instruction stored in the selecting vector register 47, in spite of trying to fetch the address XX. The CPU 6 executes the instruction as it is. As a result, the branch instruction jumps to the branch destination, so that execution of the desired interruption service routine is started.

According to the aforementioned second embodiment, when receiving the interruption request from the interruption accepting section 41, the CPU 6 reads out the branch instruction written on the selecting vector register 47 through the reading section 48 and executes the interruption service routine related to the branch instruction. As a result, the process to make a decision on the interruption-request-originated interruption factor by software can be omitted, as in the case with the first embodiment, so that the time from generation of the interruption request until commence of execution of the corresponding interruption service routine is shortened.

In addition, because the branch instruction which is sent to CPU 6 is written to the selecting vector register 47 in the ICU 4A, the described second embodiment can simplify the circuit compared with the first embodiment. Further, according to the first embodiment, when the interrupt vector INT in the EIT vectors 62 is intended to be changed via the CPU bus, there is a possible fear that a cyclic shift (bus conflict or wait) may be caused by CPU bus access. However, according to the second embodiment, since the writing is not done via the CPU bus, the possible cyclic shift caused by the CPU bus access can be avoided.

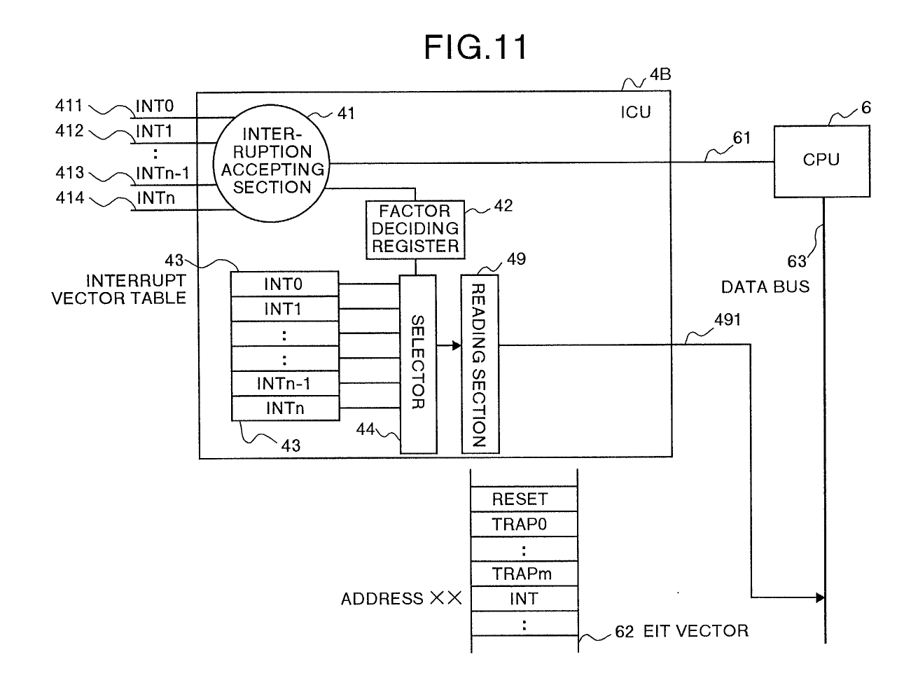

FIG. 11 is a block diagram of the third embodiment of the interruption processing device according to the present invention. The interruption processing device of the third embodiment uses a reading section 49 as a substitute for the writing section 46, the selecting vector register 47 and the reading section 48 in the ICU 4A of the second embodiment. Since the remaining constructional features are identical to those of the second embodiment, the same features as those of the second embodiment are given the same reference numerals, and explanation thereof will be omitted.

When the CPU 6 intends to read out the interrupt vector INT in the EIT vectors 62, the reading section 49 directly reads out the branch instruction selected by the selector 44 and sends it to the CPU 6 through a writing line 491 and the data bus 63.

Operation of the interruption processing device of the third embodiment will be described next. First, before a system including the interruption processing device having the structure shown in FIG. 11 is booted, circuits of the system are initialized and the interrupt vector table 43 in an ICU 4B is initialized. Then, the branch instructions to the top address in the areas in the storage device, not shown, in which the interruption service routines one for each of interruption factors, not shown, are stored are set in the interrupt vector table 43.

After an interruption request is generated from the interruption factor, not shown, the interruption accepting section 41 decides acceptance levels of the interruption and proprieties of the interruption, for determination of the interruption factors to be accepted. Then, the interruption accepting section 41 outputs the factor number for specifying the accepted interruption factor to the factor deciding register 42, so that the factor number is stored in the factor deciding register 42.

When the factor number is stored in the factor deciding register 42, the selector 44 selects from the interrupt vector table 43 the branch instruction to the top address in the storage area in which the interruption service routine of the interruption factor corresponding to the factor number is stored. Also, when the factor number is stored in the factor deciding register 42, the interruption accepting section 41 outputs the interruption request to the CPU 6 through the interruption terminal 61.

When receiving the interruption request, the CPU 6 goes into action to fetch the interrupt vector INT in address XX in the EIT vectors 62. At this time, the reading section 49 reads out the contents in the selector 44, instead of in address XX. Therefore, the CPU 6 fetches the branch instruction selected from the interrupt vector table 43 by the selector 44, in spite of trying to fetch the address XX. The CPU 6 executes the instruction as it is. As a result, the branch instruction jumps to the branch destination, so that execution of the desired interruption service routine is started.

According to the third embodiment, when receiving the interruption request from the interruption accepting section 41, the CPU 6 reads out the branch instruction selected by the selector 44 through the reading section 49 and executes the interruption service routine related to the branch instruction. As a result, the process to make a decision on the interruption-request-originated interruption factor by software can be omitted, so that the time from generation of the interruption request until commence of execution of the corresponding interruption service routine is shortened.

Also, according to the aforementioned third embodiment, the hardware can be further reduced in scale, as compared with the second embodiment, because, according to the third embodiment, the need for provision of the circuits corresponding to the writing section 46 and the selecting vector register 47 of the second embodiment can be eliminated.

As aforementioned, according to the first aspect of the present invention, when the interruption accepting section of the interruption controlling unit accepts the interruption requests sent from the plurality of interruption factors, the information for specifying the interruption factors which are a source of the interruption requests is stored in the decision information storing section. Based on the information stored in the decision information storing section, the selecting section of the interruption controlling unit selects a corresponding branch instruction from the interrupt vector table in which the branch instructions to the interruption service routines corresponding to their respective interruption factors are stored. Then, the writing section of the interruption controlling unit writes the corresponding branch instruction onto a designated interrupt vector in the EIT vectors. Then, when the CPU receives the interruption request and fetches the designated interrupt vector in the EIT vectors, the CPU executes the interruption service routine stored in the area for the branch destination of the branch instruction. Therefore, the process to make a decision on the interruption-request-originated interruption factor by software can be omitted. Thus, the time from generation of the interruption request until commence of execution of the corresponding interruption service routine is shortened.

According to the second aspect of the present invention, when the interruption accepting section of the interruption controlling unit accepts the interruption requests sent from the plurality of interruption factors, the information for specifying the interruption factors which are a source of the interruption requests is stored in the decision information storing section. Based on the information stored in the decision information storing section, the selecting section of the interruption controlling unit selects a corresponding branch instruction from the interrupt vector table in which the branch instructions to the interruption service routines corresponding to the interruption factors are stored. Then, the writing section of the interruption controlling unit writes the corresponding branch instruction onto the selected instruction storing section. Then, when the CPU receives the interruption request and intends to read the designated interrupt vector in the EIT vectors, the reading section of the interruption controlling unit exchanges data with the branch instruction written on the selected instruction storing section. The CPU executes the interruption service routine stored in the area for the branch destination of the branch instruction. Therefore, the process to make a decision on the interruption-request-originated interruption factor by software can be omitted. Thus, the time from generation of the interruption request until commence of execution of the corresponding interruption service routine is shortened.

According to the third aspect of the present invention, when the interruption accepting section of the interruption controlling unit accepts the interruption requests sent from the plurality of interruption factors, the information for specifying the interruption factors which are a source of the interruption requests are stored in the decision information storing section. Based on the information stored in the decision information storing section, the selecting section of the interruption controlling unit selects a corresponding branch instruction from the interrupt vector table in which the branch instructions to the interruption service routines corresponding to the interruption factors are stored. Then, when the CPU receives the interruption request and intends to read the designated interrupt vector in the EIT vectors, the reading section of the interruption controlling unit exchanges data with the branch instruction selected by the selecting section. The CPU executes the interruption service routine stored in the area for the branch destination of the branch instruction. Therefore, the process to make a decision on the interruption-request-originated interruption factor by software can be omitted. Thus, the time from generation of the interruption request until commence of execution of the corresponding interruption service routine is shortened.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An interruption processing device comprising:
an interruption controlling unit having an interruption accepting section for accepting interruption requests sent from a plurality of interruption factors and posting the interruption to a CPU when it accepts the interruption; a decision information storing section for storing information for specifying the interruption factors which are a source of the interruption requests accepted by said interruption accepting section; an interrupt vector table for storing branch instructions to interruption service routines corresponding to said respective interruption factors on an interruption factor basis; a selecting section for selecting a branch instruction to said related interruption service routine from said interrupt vector table, based on the information stored in said decision information storing section; and a writing section for writing the branch instruction selected by said selecting section onto a designated interrupt vector in EIT vector; and
the CPU having the capability of reading a designated interrupt vector in said EIT vector at the time of the interruption being posted from said interruption controlling unit and of executing the interruption service routine stored in a branch destination of the read branch instruction.

2. An interruption processing device comprising:
an interruption controlling unit having an interruption accepting section for accepting interruption requests sent from a plurality of interruption factors and posting generation of interruption to a CPU when accepting the interruption; a decision information storing section for storing information for specifying the interruption factors which are a source of the interruption requests accepted by said interruption accepting section; an interrupt vector table for storing branch instructions to interruption service routines corresponding to the respective interruption factors on an interruption factor basis; a selecting section for selecting a branch instruction to the corresponding interruption service routine from said interrupt vector table, based on the information stored in said decision information storing section; a selected instruction storing section for storing the branch instruction selected by said selecting section; a writing section for writing the branch instruction selected by said selecting section onto said selected instruction storing section; and a reading section for reading the branch instruction stored in said selected instruction storing section, instead of the branch instruction stored in the interrupt vector in EIT vector which should originally be read out when the CPU intends to read the branch instruction; and
the CPU having the capabilities of reading a designated interrupt vector in said EIT vector at the time of the interruption being posted from said interruption controlling unit and of executing the interruption service routine stored in the branch instruction read out by said reading section of said interruption controlling unit branches to.

3. An interruption processing device comprising:
an interruption controlling unit having an interruption accepting section for accepting interruption requests sent from a plurality of interruption factors and posting generation of interruption to a CPU when accepting the interruption; a decision information storing section for storing information for specifying the interruption factors which are a source of the interruption requests accepted by said interruption accepting section; an interrupt vector table for storing branch instructions to interruption service routines corresponding to the respective interruption factors on an interruption factor basis; a selecting section for selecting a branch instruction to the corresponding interruption service routine from said interrupt vector table, based on the information stored in said decision information storing section; and a reading section for reading the branch instruction selected by the selecting section, instead of the branch instruction stored in the interrupt vector in EIT vector which should originally be read out when said CPU intends to read the branch instruction; and
the CPU having the capabilities of reading a designated interrupt vector in said EIT vector at the time of the interruption being posted from said interruption controlling unit and of executing the interruption service routine stored in the branch instruction read out by said reading section of said interruption controlling unit branches to.
